(19) United States
(12) Patent Application Publication
(10) Pub. No.: US 2018/0115603 A1
(43) Pub. Date: Apr. 26, 2018

(54) COLLABORATOR RECOMMENDATION USING COLLABORATION GRAPHS

(71) Applicant: Microsoft Technology Licensing, LLC, Redmond, WA (US)

(72) Inventors: Rui Hu, Redmond, WA (US); Patrick Michael Conlan, Seattle, WA (US); Sandipan Ganguly, Redmond, WA (US); Si-Qing Chen, Bellevue, WA (US); Sihong Liu, Redmond, WA (US); Yi-Lei Wu, Sammamish, WA (US)

(21) Appl. No.: 15/299,321

(22) Filed: Oct. 20, 2016

(51) Int. Cl. H04L 29/08; G06F 17/30

(52) U.S. Cl. CPC H04L 67/1087; G06F 17/3053; G06F 17/30958

(57) ABSTRACT

Aspects of the present disclosure relate to systems and methods for providing recommended collaborators. In one aspect, collaboration data associated with at least one application may be received at a data modeling service. A collaboration graph for representing the collaboration data associated with the at least one application may be created. The collaboration graph may be queried to identify a plurality of recommended collaborators for collaborating within the at least one application. The plurality of recommended collaborators may be ranked in a ranking order based on a set of criteria.

### BACKGROUND

Computer and software users have grown accustomed to user-friendly software applications for co-authoring files, documents, messages, and the like. For example, storage providers (e.g., cloud storage providers) provide applications such as word processing applications, spreadsheet applications, electronic slide presentation applications, email applications, chat applications, voice applications, and the like, where users can co-author and collaborate with one another within the applications. Collaboration includes identifying collaborators/users for sharing documents and/or utilizing other collaboration features. Current techniques for identifying other users to collaborate with require manually typing in the name of other potential users, and sometimes in a sequence. Such techniques are tedious and error-prone as heavy typing is required. As such, current techniques for identifying users for document collaboration may be cumbersome, difficult, and inefficient, ultimately resulting in a lack of participating in document collaboration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for providing recommended collaborators. In one aspect, collaboration data associated with at least one application may be received at a data modeling service. A collaboration graph for representing the collaboration data associated with the at least one application may be created. The collaboration graph may be queried to identify a plurality of recommended collaborators for collaborating within the at least one application. The plurality of recommended collaborators may be ranked in a ranking order based on a set of criteria.

In another aspect, receiving a request for recommended collaborators for collaborating within at least one application may be received. A collaboration graph to identify a plurality of recommended collaborators for collaborating within the at least one application may be queried. A ranking order of the plurality of recommended collaborators may be determined based on a set of criteria. A list of recommended collaborators based on the ranking order may be sent to a client computing device for display in a user interface.

In yet another aspect, a method for updating a ranking order of recommended collaborators may be presented. In one example, an indication of a selection of at least one recommended collaborator displayed within an application in a user interface may be received. The indication of the selection of the at least one recommended collaborator may be recorded at a data modeling service. A priority of a plurality of weights assigned to collaboration data associated with the application may be adjusted. A ranking order of the recommended collaborators may be updated based at least in part on the adjusted priority of the plurality of weights assigned to the collaboration data associated with the application.

### DESCRIPTION OF THE DRAWINGS

The detailed description is made with reference to the accompanying figures. In the figures, the left-most digit(s) of a reference number identifies the figure in which the reference number first appears. The use of the same reference numbers in different instances in the description and the figures may indicate similar or identical items.

FIG. 1A illustrates an exemplary collaboration system for providing recommended collaborators, according to an example aspect.

FIG. 1B illustrates an exemplary data modeling service for providing recommended collaborators, according to an example aspect.

FIG. 2 illustrates an exemplary collaboration graph for modeling collaboration data, according to an example aspect.

FIG. 3 illustrates one view of a word processing application displayed on a user interface of a client computing device, according to an example aspect.

FIG. 4 illustrates an exemplary method for providing recommended collaborators, according to an example aspect.

FIG. 5 illustrates an exemplary method for updating a ranking order of recommended collaborators, according to an example aspect.

FIG. 6 illustrates a computing system suitable for implementing the enhanced collaboration technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to providing recommended collaborators. For example, a file such as a word document created by an application may include one or more collaboration features such as sharing the file. In this regard, when a user decides to share the file, the user may invite other users to collaborate within the file. In one example, an invite and/or share option may be selected to trigger sharing and/or collaborating within the file. In some examples, in response to a selection of the invite and/or sharing option, the collaboration system of the present disclosure may receive a request for recommended collaborators for collaborating within the file. In this regard, a data modeling service may include a collaboration graph for providing recommended collaborators. The collaboration graph may model and/or represent collaboration data associated with the file, the user requesting recommended collaborators and/or the recommended collaborators. For example, the collaboration data may include email data, instant messaging data, historical file data, organizational hierarchy data, meeting data, file contextual data, expertise data, and user influence data. The collaboration graph may include the collaboration data for providing recommended collaborators. In some examples, the collaboration graph may be queried and a ranking order of recommended collaborators may be determined. A list of the most relevant recommended collaborators, e.g., based on the determined ranking order, may be returned to the user and displayed in a user interface. As such, the user may quickly and efficiently identify one or more users with whom they want to share their file and/or collaborate with without spending time manually typing in the full name of another user, for example.

As discussed above, current techniques for identifying other users to collaborate with require manually typing in the name of other potential users, and sometimes in a sequence. Such techniques are tedious and error-prone as heavy typing is required. As such, current techniques for identifying users for document collaboration may be cumbersome, difficult, and inefficient, ultimately resulting in a lack of participating in document collaboration. Accordingly, aspects described herein include techniques that make collaborating with another user/collaborator of a file and/or application intuitive, user-friendly, and efficient. For example, by dynamically providing recommended collaborators to collaborate with in a file and/or an application before and/or as a user is typing in the name of another user/collaborator, a user can quickly select a recommended collaborator from her most relevant potential collaborators and/or contacts without having to risk making a mistake.

As such, a technical effect that may be appreciated is that by representing and/or modeling collaboration data using a collaboration graph for determining the most relevant collaborators to recommend to a user collaborating on documents and/or within applications processor load may be reduced, memory may be conserved, and network bandwidth usage may be reduced. Another technical effect that may be appreciated is that users and/or co-authors/collaborators of a file may quickly, easily, and efficiently view and select those collaborators that are most relevant to them while collaborating within applications. Yet another technical effect that may be appreciated is that displaying at least some of a plurality of recommended collaborators in a user interface before and/or as a user is typing in the name of another user/collaborator facilitates a compelling visual and functional experience to allow a user to efficiently interact with a user interface for collaborating and/or co-authoring within applications. Another technical effect that may be appreciated is that an order of other recommended collaborators may be adjusted as a user is typing in the name of and/or selecting another user/collaborator from the user interface by assigning a greater weight to at least common neighbors of the user and/or a selected user/collaborator.

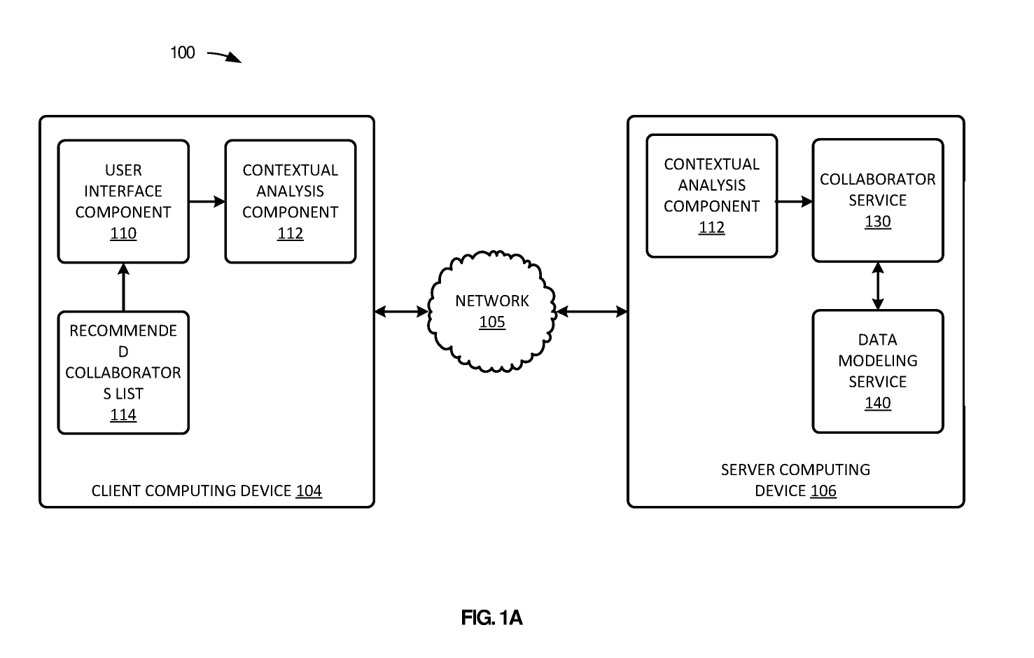

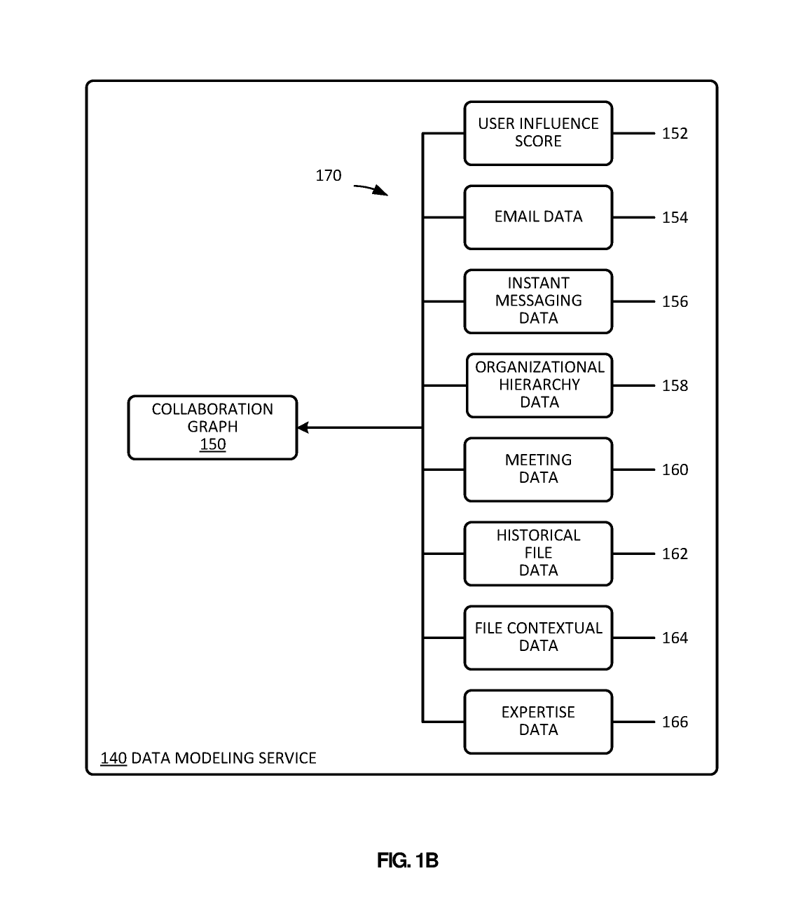

Referring now to the drawings, in which like numerals represent like elements through the several figures, aspects of the present disclosure and the exemplary operating environment will be described. With reference to FIG. 1A, one aspect of a collaboration system 100 for providing recommended collaborators is illustrated. The collaboration system 100 may include a client computing device 104 and a server computing device 106. In aspects, the collaboration system 100 may be implemented on the client computing device 104. In a basic configuration, the client computing device 104 is a handheld computer having both input elements and output elements. The client computing device 104 may be any suitable computing device for implementing the collaboration system 100 for providing recommended collaborators. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the collaboration system 100 for providing recommended collaborators may be utilized.

In aspects, the collaboration system 100 may be implemented on the server computing device 106. The server computing device 106 may provide data to and from the client computing device 104 through a network 105. In aspects, the collaboration system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In another aspect, the collaboration system 100 may be implemented as a web-based application. In one example, the web-based application may include any client-server software application where the client (e.g., user interface) runs in a web-browser and/or any component capable of rendering HTML, Flash, Silverlight, and the like.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The various components may be implemented using hardware, software, or a combination of hardware and software. In aspects, the client computing device 104 may include a user interface component 110, a contextual analysis component 112, and a recommended collaborators list 114. The user interface component 110 may facilitate providing recommended collaborators. For example, the user interface component 110 may initiate rendering of a file created with an application in a user interface of the client computing device 104. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation.

In another example, the file may include at least one collaboration feature. In one example, the at least one collaboration feature may include inviting other users and/or collaborators to collaborate within the file. For example, a list including one or more recommended collaborators associated with a user of the file may be presented in response to receiving an indication of interest made with respect to an invite icon. In some cases, the list is presented within a picker displayed in the user interface of the client computing device 104. In this regard, a user may select at least one recommended collaborator with whom to collaborate within in the file. In another example, a list including one or more recommended collaborators associated with a user of the file may be presented at any time while the user is within the file.

In one aspect, in response to receiving an indication of interest made with respect to the at least one collaboration feature (e.g., an invite icon), the contextual analysis component 112 may perform an analysis of the contextual information of the file (e.g., file contextual data). In one example, an indication of interest may include touching, clicking on, audibly referencing, pointing to, selecting, and/or any indication of an interest in or selection of the at least one collaboration feature. In one example, the file contextual data may include a file type, title, topic, user identifier and/or keywords. As such, performing an analysis of the contextual information of the file may include searching the file and/or identifying the file type, the title of the file, the topic of the file, keywords included in the file, and/or an identifier associated with the user of the file requesting recommended collaborators. In this regard, the contextual analysis component 112 may send a request for recommended collaborators to the server computing device 106. In one example, the request for recommended collaborators may include the contextual information identified within the file.

In some aspects, the server computing device 106 may include the contextual analysis component 112, a collaborator service 130 and a data modeling service 140. As discussed above, the contextual analysis component 112 may perform an analysis of the contextual information of the file (e.g., file contextual data). In some examples, when the contextual analysis component 112 is located at the server computing device 106, the contextual analysis component 112 may send a request for recommended collaborators to the collaborator service 130. In some examples, the contextual analysis component 112 is part of and/or located at the client computing device 104. In other examples, the contextual analysis component 112 is part of and/or located at the server computing device 106. In other examples, one or more components of the contextual analysis component 112 are located at the client computing device 104 and one or more components of the contextual analysis component 112 are located at the server computing device 106 such that the contextual analysis component 112 is located at both the client computing device 104 and the server computing device 106.

In one example, the collaborator service 130 may be configured to collect, store, manage, and access data and/or information associated with the collaboration system 100. For example, the collaborator service 130 may collect and store one or more files, collaboration data associated with a file, and/or one or more contacts associated with a user of the file. In another example, the collaborator service 130 may receive data associated with a file created with an application. For example, the client computing device 104 may provide data to and from the server computing device 106 through the network 105. In some examples, the data may include the contextual information identified within the file and sent with the request for recommended collaborators. In this regard, the collaborator service 130 may receive a request for recommended collaborators for collaborating within the file. In one example, the collaborator service 130 includes an application programming interface (API) (e.g., a REST API) for receiving the request including contextual information for recommended collaborators for collaborating within the file. In another example, the REST API may send data, information, and/or a query (e.g., including the request with contextual information of the file) to the data modeling service 140.

In some examples, the data modeling service 140 may include a collaboration graph. In this regard, the data modeling service 140 may be configured to create a collaboration graph for representing and/or modeling collaboration data associated with the file. In one example, the collaboration graph may be created using data and/or information associated with the collaboration system 100. In this regard, the data modeling service 140 may receive, collect and/or access data and/or information associated with the collaboration system 100. For example, the data modeling service 140 may receive, collect and store one or more files, collaboration data associated with a file, and/or one or more contacts associated with a user of the file. In another example, the data modeling service 140 may receive data associated with a file created with an application. In some examples, the data may include the contextual information identified within the file and sent with the request for recommended collaborators. In some examples, the collaboration data represented by the collaboration graph includes email data, instant messaging data, historical file data, organizational hierarchy data, meeting data, file contextual data, expertise data, and user influence data, which will be discussed in detail relative to FIG. 1B. In one example, the data modeling service 140 may receive data from the collaboration service 130.

In aspects, the data modeling service 140 may be part of and/or located at the collaborator service 130. In another example, data modeling service 140 may be a separate component and/or may be located separate from the collaborator service 130. It is appreciated that although one server computing device 106 is illustrated in FIG. 1A, the collaboration system 100 may include a plurality of server computing devices 106 with a plurality of collaborator services 130 and a plurality of data modeling services 140. In some cases, the server computing device 106 may include a plurality of collaborator services 130 and a plurality of data modeling services 140. For example, the plurality of collaborator services 130 may include at least file storage providers, external activity services and document editing clients. In one example, the collaborator service 130 may be a cloud storage service such as OneDrive, SharePoint, Google Drive, Dropbox, and the like.

In one example, the collaboration graph includes a plurality of nodes and a plurality of edges. Each node of the plurality of nodes may represent a user and/or collaborator of the file associated with and/or created with an application. For example, each node of the plurality of nodes may include collaboration data associated with the user of the file. In another example, each node of the plurality of nodes may include collaboration data associated with one or more collaborators of the file. In some cases, the plurality of nodes represent a plurality of recommended collaborators associated with the file and include collaboration data associated with the plurality of recommended collaborators. In one case, each edge of the plurality of edges connects two nodes. For example, a first edge of the collaboration graph may connect a first node to a second node. In another example, each edge of the plurality of edges may include an indication of a number of files that have been collaborated on between each user associated with each node connected by the edge. For example, if user A (e.g., node A) is connected to user B (e.g., node B) via an edge, and user A and user B have collaborated on 100 files together, the edge connected node A and node B may include an indication of 100.

In one example, in response to receiving a request for recommended collaborators, the data modeling service 140 may query the collaboration graph to identify a plurality of recommended collaborators for collaborating within the file and/or application. For example, querying a collaboration graph to identify a plurality of recommended collaborators for collaborating within the file and/or application may include identifying a starting node from the plurality of nodes. For example, the starting node may be associated with the user requesting recommended collaborators. That is, the starting node may represent the user requesting recommended collaborators.

In one case, querying a collaboration graph to identify a plurality of recommended collaborators for collaborating within the file and/or application may include identifying a set of nodes from the plurality of nodes having a predetermined distance from the starting node. The predetermined distance may be a number of “steps” that any one node is away from the starting node. For example, the predetermined distance may include “one step,” “two steps,” “three steps,” etc. In one example, a predetermined distance of “one step” may include the plurality of nodes representing users/collaborators who have directly collaborated with the user represented by the starting node. In another example, a predetermined distance of “two steps” may include the plurality of nodes representing users/collaborators who have collaborated with users/collaborators who have directly collaborated with the user represented by the starting node, but who have not themselves directly collaborated with the user represented by the starting node. In another example, a predetermined distance of “three steps” may include the plurality of nodes representing users/collaborators who have collaborated with users/collaborators represented by nodes having a predetermined distance of “two steps”. In some cases, the plurality of recommended collaborators identified may include the collaborators represented by nodes having a predetermined distance of “one step”. In some cases, the plurality of recommended collaborators identified may include the collaborators represented by nodes having a predetermined distance of “two steps”. In some cases, the plurality of recommended collaborators identified may include the collaborators represented by nodes having a predetermined distance of “three steps”. In some cases, the plurality of recommended collaborators identified may include the collaborators represented by nodes having any of and/or any combination of a predetermined distance.

In aspects, the plurality of identified recommended collaborators may be ranked in a ranking order based on a set of criteria. The set of criteria may include a collaboration frequency, a collaboration recency, a collaboration distance, file contextual data, expertise data, and a user influence score. The collaboration frequency may include a measurement of a number of interactions associated with the collaboration data between the user requesting recommended collaborators (e.g., represented by the starting node) and a recommended collaborator. The interactions associated with the collaboration data may include interactions such files collaborated on together, communication correspondence such as emails and/or instant messages sent between the user and a recommended collaborator, meetings scheduled and/or phone calls between the user and a recommended collaborator, similarities in contextual information, topics and/or expertise of files associated with the user and a recommended collaborator, and the like. For example, if user A and user B have collaborated on 100 files together, the collaboration frequency between user A and user B may be 100.

The collaboration recency may include a measurement of an amount of time since the user requesting recommended collaborators collaborated with a recommended collaborator. For example, if user A collaborated with user B one week ago, the collaboration recency would be one week. The collaboration distance is the predetermined distance between the user requesting recommended collaborators and a recommended collaborator, as discussed herein. For example, if the recommended collaborator is “one step” away from the user requesting recommended collaborators, the collaboration distance is “one step”. The file contextual data may include a file type, title, topic, user identifier and/or keywords of the file. The expertise data may include data associated with an expertise of the user requesting recommended collaborators and a recommended collaborator. For example, if a recommended collaborator is an expert in communications, the recommended collaborator may have a tag indicating such expertise which may be included in the expertise data. The user influence score may be a score calculated and assigned to a recommended collaborator based on a number of connections of the recommended collaborator and/or influence scores of collaborators connected with the recommended collaborator (e.g., having a distance of “one step”).

In one case, ranking the plurality of recommended collaborators in a ranking order based on the set of criteria may include a plurality of calculations/measurements. In one example, ranking the plurality of recommended collaborators in a ranking order based on the set of criteria may include measuring the collaboration frequency, the collaboration recency, and the collaboration distance. In another example, ranking the plurality of recommended collaborators in a ranking order based on the set of criteria may include identifying similarities between the file contextual data of a user requesting recommended collaborators and the file contextual data of a recommended collaborator and/or the plurality of recommended collaborators. In another example, ranking the plurality of recommended collaborators in a ranking order based on the set of criteria may include identifying similarities between the file contextual data of the user requesting recommended collaborators and the expertise data of a recommended collaborator and/or the plurality of recommended collaborators. In another example, ranking the plurality of recommended collaborators in a ranking order based on the set of criteria may include calculating the user influence score of a recommended collaborator and/or the plurality of recommended collaborators. In another example, ranking the plurality of recommended collaborators in a ranking order based on the set of criteria may include assigning a plurality of weights to the collaboration data associated with the plurality of recommended collaborators. For example, each piece of collaboration data (e.g., email data, instant messaging data, historical file data, organizational hierarchy data, meeting data, file contextual data, expertise data, and user influence data) may have a weight assigned to it. In this regard, a piece of collaboration data having a greater weight assigned to it may be given a higher priority while ranking the plurality of recommended collaborators. In some cases, ranking the plurality of recommended collaborators in a ranking order based on the set of criteria may include utilizing any of and/or any combination of the methods, calculations and/or measurements described herein.

In some examples, when a ranking order of recommended collaborators is determined, the data modeling service 140 may create a list of recommended collaborators based on the ranking order. For example, a recommended collaborator having the highest ranking may be included in the top of the list of recommended collaborators for presenting to the user requesting recommended collaborators. In some cases, a number of recommended collaborators having the highest ranking may be included in the list of recommended collaborators for presenting to a user for collaborating within a file. For example, at least some of the recommended collaborators having a highest ranking may be included in the list of recommended collaborators. Any number of recommended collaborators may be included in the list of recommended collaborators for presenting to a user for collaborating within a file.

For example, the ten collaborators having the highest ranking may be included in the list of recommended collaborators. In another example, the five collaborators having the highest ranking may be included in the list of recommended collaborators.

In another example, the data modeling service 140 may send the list of recommended collaborators to the client computing device 104 based on the ranking order. In this regard, the user interface component 110 and/or the file rendered in the user interface may display the recommended collaborators list 114 within a file in the user interface. In one example, the recommended collaborators list 114 may be displayed within a picker displayed in the user interface. In one example, the picker is displayed in the user interface proximal to the file content.

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

With reference now to FIG. 1B an exemplary data modeling service 140 for providing recommended collaborators, according to an example aspect is illustrated. The data modeling service 140 includes all the functionality described above herein relative to FIG. 1A. In one aspect, the data modeling service 140 includes a collaboration graph 150 and collaboration data 170. As discussed above, the data modeling service 140 may be configured to create the collaboration graph 150 for representing and/or modeling the collaboration data 170. In one example, the collaboration data 170 includes a user influence score 152, email data 154, instant messaging data 156, organizational hierarchy data 158, meeting data 160, historical file data 162, file contextual data 164, and expertise data 166. In one example, the user influence score 152 may be calculated based on a number of connections of a recommended collaborator and/or calculated influence scores of collaborators connected with the recommended collaborator. For example, the user influence score 152 may be affected by four factors: the number of outbound connections, the influence scores of neighbors (e.g., nodes/users “one step” away), an intensity of collaboration, and a number of inbound connections of neighbors. In one example, the PageRank algorithm (e.g., as known to one having ordinary skill in the art) may be used to calculate the user influence score 152.

In another example, an edge-weighted PageRank algorithm may be used to calculate the user influence score 152. For example, the stochastic matrix A may be adjusted such that each entry becomes:

$${A}_{u , v} = \frac{W ( u , v )}{{\sum }_{k ∈ N ( v )} - W ( {k}^{′} v )}$$

where W(u,v) is the weight of an edge from node u to v, and N(v) is the inbound neighbors of node v. The damping factor, d, in the PageRank algorithm may control how much of an influence score a node may gain from one or more neighbors. In one example, the damping factor, d, may be set to 0.6. In some cases, the collaboration graph 150 may include at least one dangling node. A dangling node is a node that receives a PageRank user influence score 152 but does not pass the user influence score 152 on to a neighbor. In this case, a backlink may be created for the dangling node. For example, the backlink may include an edge that connects from the neighbor who did not receive the user influence score 152 to the dangling node. In some cases, the collaboration graph 150 may include isolated nodes. Isolated nodes may include one or more nodes (e.g., users) that don't collaborate with other nodes (e.g., users). In some examples, the isolated nodes may have a smaller user influence score 152 than other nodes that do collaborate. The isolated nodes may give user influence scores 152 equally to all other nodes in the collaboration graph 150. In some cases, the user influence score 152 may be calculated using a C# implementation of the PageRank algorithm and a Reducer. For example, the stochastic matrix space may be represented efficiently as each vertex (e.g., node) may only allow limited memory space. In another example, full matrix multiplications may be avoided to improve performance In another example, the user influence score 152 may be calculated once for isolated nodes.

In one example, the email data 154 may include communication activities such as email communications. In this regard, the email data 154 may include data such as the contacts a user sends emails to and the contacts the user receives emails from. In another example, the email data 154 may include content of emails sent to and received from contacts associated with a user. In one example, instant messaging data 156 may include communication activities such as instant messaging communications. In this regard, the instant messaging data 156 may include data such as the contacts a user sends instant messages to and the contacts a user receives instant messages from. In another example, the instant messaging data 156 may include content of instant messages sent to and received from contacts associated with a user. In one example, the organizational hierarchy data 158 may include data associated with a user's organization. For example, the organizational hierarchy data 158 may include contact information and/or content of colleagues a user works with regularly, the user's boss, employees a user gives work to, employees and/or colleagues a user collaborates with, and the like. In one example, the meeting data 160 may include contact information of people a user has been in meeting with and/or people who the user regularly has meetings with. In another example, the meeting data 160 may include content associated with a meeting a user participates in such as the topic of a meeting, what was discussed in the meeting, and the like.

In one example, the historical file data 162 may include data from past collaborations. For example, the historical file data 162 may include the contacts a user has previously collaborated with in files, communications (e.g., emails, instant messages, phone calls), and the like. In another example, the historical file data 162 may include content of files, communications (e.g., emails, instant messages, phone calls), and the like, that a user has previously collaborated on with other users/collaborators/contacts (e.g., files and communications that have been shared, edited, discussed). In one example, the file contextual data 164 may include a file type, title, topic, user identifier and/or keywords associated with a file, an email, an instant message, and the like and/or content of a file, an email, an instant message, and the like. In one example, the file contextual data 164 may be identified and/or extracted from a file, email, instant message, etc. using natural language processing techniques. In one example, the expertise data 166 may include data associated with an expertise of a user and/or collaborators. For example, the expertise data 166 may include contact information of collaborators who are experts in an area/topic associated with content of a file authored by a user. In another example, the expertise data 166 may include content associated with the expertise of a user and/or collaborator. In one example, the expertise data 166 may be associated with collaborators who are outside of a user's network and/or organization.

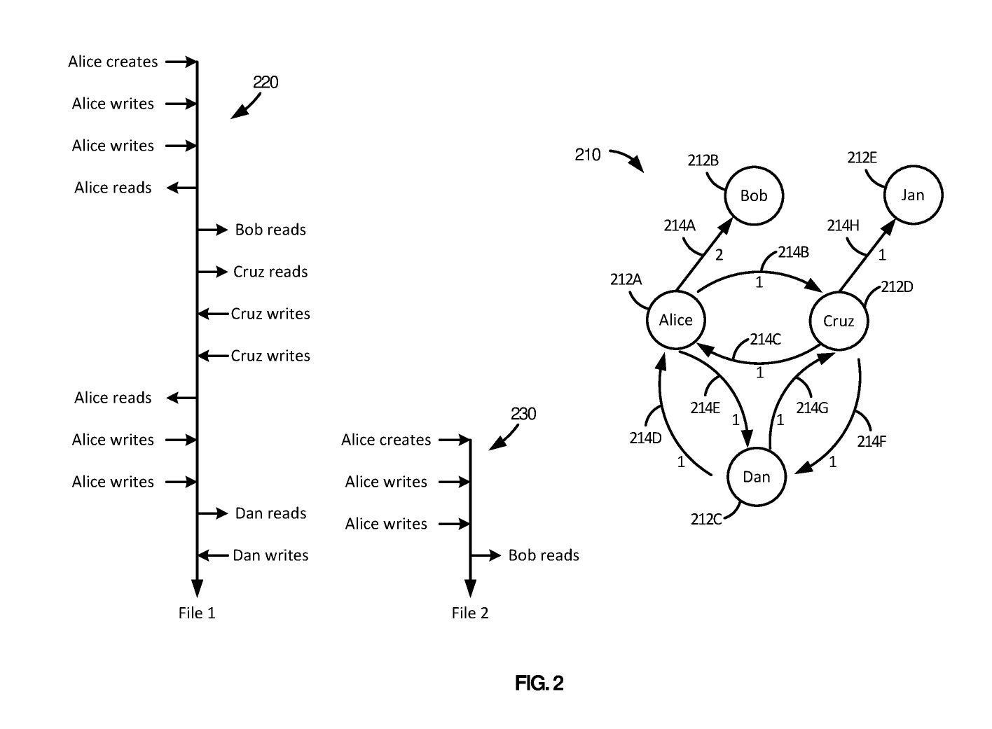

Referring now to FIG. 2, an exemplary collaboration graph 210 for modeling collaboration data is shown. The collaboration graph 210 includes a plurality of nodes 212A-212E and a plurality of edges 214A-214H. Each node of the plurality of nodes 212A-212E represents a user and/or collaborator of File 1 and File 2, as illustrated in FIG. 2. File 1 includes a collaboration tree 220 and file 2 includes a collaboration tree 230. The collaboration tree 220 shows the interactions/collaboration of users/collaborators associated with File 1. The collaboration tree 230 shows the interactions/collaboration of users/collaborators associated with File 2. As illustrated in FIG. 2, Alice is the author/creator of File 1 and File 2 and is represented by node 212A. The edge 214A connects node 212A (e.g., representing Alice) to node 212B (e.g., representing Bob). As illustrated in FIG. 2, the edge 214A has an indication of 2. In this regard, the indication of 2 associated with the edge 214A indicates that Alice and Bob have collaborated with each other twice (e.g., the collaboration frequency is 2). In the example illustrated in FIG. 2, Alice and Bob have collaborated on two files, File 1 and File 2. The collaboration tree 220 shows that Alice creates File 1, edits File 1, and Bob reads File 1. The collaboration tree 230 shows that Alice creates File 2, edits File 2, and Bob reads File 2. In one example, collaboration begins when the author/creator of a file makes an edit to the file (e.g., begins writing in a file). In another example, collaboration begins when the author/creator of a file makes their last edit to the file.

As illustrated in FIG. 2, the edge 214B connects node 212A (e.g., representing Alice) to node 212D (e.g., representing Cruz). The edge 214B has an indication of 1. In this regard, the indication of 1 associated with the edge 214B indicates that Alice and Cruz have collaborated with each other once. In the example illustrated in FIG. 2, Alice and Cruz have collaborated on File 1. The collaboration tree 220 shows that Alice creates File 1, edits File 1 and Cruz reads File 1, edits File 1. In this regard, as illustrated in FIG. 2, the edge 214C connects Cruz to Alice (e.g., node 212D to node 212A) and has an indication of 1. In one example, the edge 214B indicates that Alice has an impact on Cruz (e.g., Alice edits File 1 and Cruz reads File 1). In another example, the edge 214C indicates that Cruz has an impact on Alice (e.g., Cruz edits File 1 and Alice reads File 1 after Cruz edits File 1).

As illustrated in FIG. 2, the edge 214E connects node 212A (e.g., representing Alice) to node 212C (e.g., representing Dan). The edge 214E has an indication of 1. In this regard, the indication of 1 associated with the edge 214E indicates that Alice and Dan have collaborated with each other once. In the example illustrated in FIG. 2, Alice and Dan have collaborated on File 1. The collaboration tree 220 shows that Alice creates File 1, edits File 1 and Dan reads File 1, edits File 1. In this regard, as illustrated in FIG. 2, the edge 214D connects Dan to Alice (e.g., node 212C to node 212A) and has an indication of 1. In one example, the edge 214E indicates that Alice has an impact on Dan (e.g., Alice edits File 1 and Dan reads File 1). In another example, the edge 214D indicates that Dan has an impact on Alice (e.g., Dan edits File 1).

As illustrated in FIG. 2, the edge 214G connects node 212C (e.g., representing Dan) to node 212D (e.g., representing Cruz). The edge 214G has an indication of 1. In this regard, the indication of 1 associated with the edge 214G indicates that Dan and Cruz have collaborated with each other once. In the example illustrated in FIG. 2, Dan and Cruz have collaborated on File 1. The collaboration tree 220 shows that Cruz reads File 1, edits File 1 and Dan reads File 1, edits File 1. In this regard, as illustrated in FIG. 2, the edge 214F connects Cruz to Dan (e.g., node 212D to node 212C) and has an indication of 1. In one example, the edge 214G indicates that Dan has an impact on Cruz (e.g., Dan edits File 1). In another example, the edge 214F indicates that Cruz has an impact on Dan (e.g., Cruz edits File 1 and Dan reads File 1).

As illustrated in FIG. 2, the edge 214H connects node 212D (e.g., representing Cruz) to node 212E (e.g., representing Jan). The edge 214H has an indication of 1. In this regard, the indication of 1 associated with the edge 214H indicates that Cruz and Jan have collaborated with each other once. In the example illustrated in FIG. 2, Cruz and Jan have collaborated on a file, communication, etc., other than File 1 and File 2. In this regard, Jan is not directly connected with Alice. As such, the collaboration distance (e.g., predetermined distance) between Alice and Jan is “two steps”.

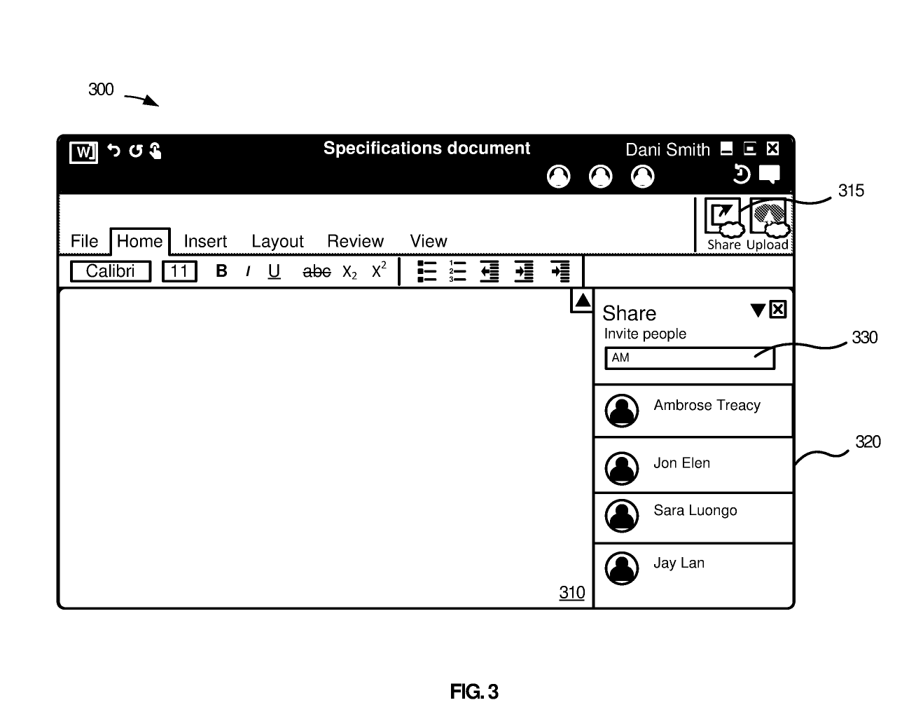

Referring now to FIG. 3, one view 300 of a word processing application displayed on a user interface of the client computing device 104, such as a desktop computer, tablet computer or a mobile phone, for example, is shown. The exemplary application, as shown in FIG. 3, is a word processing application. In one example, an application may include any information processing application suitable for collaboration and/or co-authoring such as a word processing application, spreadsheet application, and electronic slide presentation application. In one case, a file associated with the application may include a word document, a spreadsheet, and/or an electronic slide presentation. As such, an exemplary application may be a word processing application, as illustrated in FIG. 3. In this example, an exemplary file associated with the word processing application may include a word document.

As illustrated, the exemplary view 300 of the word processing application displayed on the client computing device 104 includes a file 310, a collaboration feature 315, a picker 320, and an invite box 330. The collaboration feature 315 illustrated in FIG. 3 is a share icon. In one example, in response to receiving an indication of interest made with respect to the collaboration feature 315, a plurality of recommended collaborators may be received. In one example, an indication of interest may include touching, clicking on, audibly referencing, pointing to, selecting, and/or any indication of an interest in or selection of the collaboration feature 315. As illustrated in FIG. 3, when the plurality of recommended collaborators is received, at least some of the plurality of recommended collaborators may be displayed within the picker 320 based on a determined ranking order of the recommended collaborators, as discussed herein. In the example illustrated in FIG. 3, four recommended collaborators are displayed. In this case, the four recommended collaborators displayed within the picker 320 have the highest ranking in the ranking order of recommended collaborators.

In another example, in response to receiving an indication of interest made with respect to the invite box 330, a plurality of recommended collaborators may be received. For example, when a user begins to type in the name of a contact/collaborator (e.g., in this example “AM”), a plurality of recommended collaborators may be received. In this regard, recommended collaborators may be dynamically provided to collaborate with in a file and/or an application before and/or as a user is typing in the name of another user/collaborator. In turn, a user can quickly select a recommended collaborator from her most relevant potential collaborators and/or contacts without having to risk making a mistake.

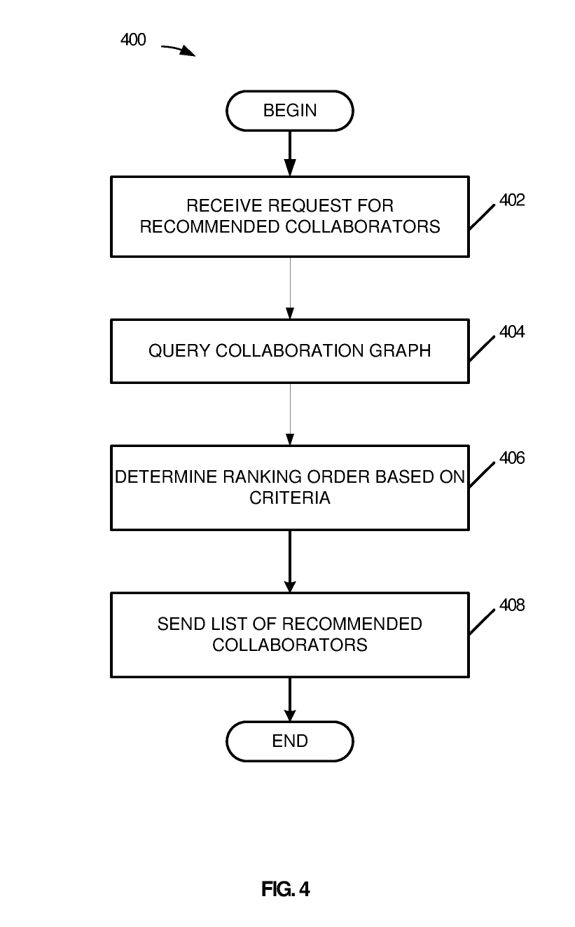

Referring now to FIG. 4, an exemplary method 400 for providing recommended collaborators, according to an example aspect is shown. Method 400 may be implemented on a computing device or a similar electronic device capable of executing instructions through at least one processor. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for providing recommended collaborators may be utilized by method 400, including combinations of the above-listed applications.

Method 400 may begin at operation 402, where a request for recommended collaborators for collaborating within at least one application is received. In one example, the request for recommended collaborators may include the contextual information identified within the file. In one example, the file contextual information/data may include a file type, title, topic, user identifier and/or keywords. In one example, the request for recommended collaborators for collaborating within the file may be received at a collaborator service. In another example, the request for recommended collaborators for collaborating within the file may be received at a data modeling service. In one example, the collaborator service includes an application programming interface (API) (e.g., a REST API) for receiving the request for recommended collaborators for collaborating within the file. In another example, the REST API may send data, information, and/or a query (e.g., including the request with contextual information of the file) to the data modeling service.

When a request for recommended collaborators for collaborating within at least one application is received, flow proceeds to operation 404 where a collaboration graph is queried to identify a plurality of recommended collaborators for collaborating within the at least one application. In one example, the collaboration graph includes a plurality of nodes and a plurality of edges. Each node of the plurality of nodes may represent a user and/or collaborator of the file associated with and/or created with an application. For example, each node of the plurality of nodes may include collaboration data associated with the user of the file. In another example, each node of the plurality of nodes may include collaboration data associated with one or more collaborators of the file. In some cases, the plurality of nodes represent a plurality of recommended collaborators associated with the file and include collaboration data associated with the plurality of recommended collaborators. In one case, each edge of the plurality of edges connects two nodes. In one example, querying a collaboration graph to identify a plurality of recommended collaborators for collaborating within the file and/or application may include identifying a starting node from the plurality of nodes. For example, the starting node may be associated with the user requesting recommended collaborators. That is, the starting node may represent the user requesting recommended collaborators. In another example, querying a collaboration graph to identify a plurality of recommended collaborators for collaborating within the file and/or application may include identifying a set of nodes from the plurality of nodes having a predetermined distance from the starting node.

When a collaboration graph is queried to identify a plurality of recommended collaborators for collaborating within the at least one application, flow proceeds to operation 406 where a ranking order of the plurality of recommended collaborators is determined based on a set of criteria. In one example, the set of criteria may include a collaboration frequency, a collaboration recency, a collaboration distance, file contextual data, expertise data, and a user influence score. In one case, ranking the plurality of recommended collaborators in a ranking order based on the set of criteria may include a plurality of calculations/measurements. In one example, the smaller the collaboration distance of a recommended collaborator from a user of a starting node, the higher the ranking will be of the recommended collaborator in the ranking order. In one example, the higher the collaboration frequency of a recommended collaborator with a user of a starting node, the higher the ranking will be of the recommended collaborator in the ranking order. In one example, the higher the collaboration recency of a recommended collaborator with a user of a starting node, the higher the ranking will be of the recommended collaborator in the ranking order. In one example, the more relevant the content of a file (e.g., the more relevant the file contextual data and/or expertise data, the more similarities) of a recommended collaborator with a user of a starting node, the higher the ranking will be of the recommended collaborator in the ranking order. In one example, the higher the user influence score of a recommended collaborator, the higher the ranking will be of the recommended collaborator in the ranking order.

When a ranking order of the plurality of recommended collaborators is determined based on a set of criteria, flow proceeds to operation 408 where a list of recommended collaborators based on the ranking order is sent to a client computing device for display in a user interface. In this regard, a user interface component and/or the file rendered in the user interface may display the list of recommended collaborators within a file in the user interface. In one example, the list of recommended collaborators may be displayed within a picker displayed in the user interface. In one example, the picker is displayed in the user interface proximal to the file content. In one example, a recommended collaborator having the highest ranking may be included in the top of the list of recommended collaborators for presenting to the user requesting recommended collaborators. In some cases, a number of recommended collaborators having the highest ranking may be included in the list of recommended collaborators for presenting to a user for collaborating within a file. For example, at least some of the recommended collaborators having a highest ranking may be included in the list of recommended collaborators. Any number of recommended collaborators may be included in the list of recommended collaborators for presenting to a user for collaborating within a file. For example, the ten collaborators having the highest ranking may be included in the list of recommended collaborators. In another example, the five collaborators having the highest ranking may be included in the list of recommended collaborators.

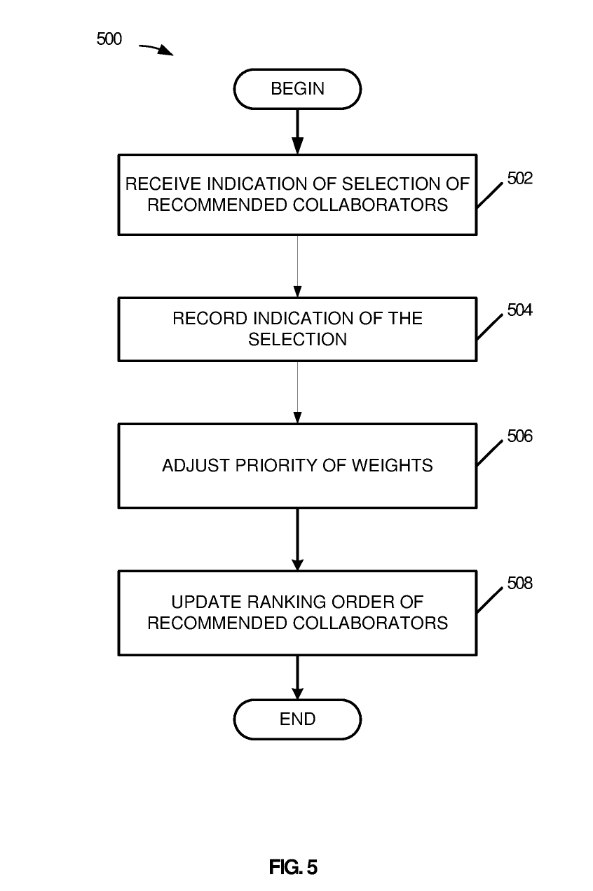

Referring now to FIG. 5, an exemplary method 500 for updating a ranking order of recommended collaborators, according to an example aspect is shown. Method 500 may be implemented on a computing device or a similar electronic device capable of executing instructions through at least one processor. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for providing dynamic contact suggestions may be utilized by method 500, including combinations of the above-listed applications.

Method 500 may begin at operation 502, where an indication of a selection of at least one recommended collaborator displayed within an application in a user interface is received. For example, a list of recommended collaborators based on a ranking order may be sent to a client computing device for display in a user interface. In this regard, a user may select a recommended collaborator from the list with whom she is interested in collaborating with (e.g., sharing a file, editing a file, etc.) In response to the selection of a recommended collaborator, an indication of the selection may be sent to and received by a collaboration service and/or a data modeling service.

When an indication of a selection of at least one recommended collaborator displayed within an application in a user interface is received, flow proceeds to operation 504 where the indication of the selection of the at least one recommended collaborator is recorded at a data modeling service. In one example, the data modeling service may be configured to collect, store, manage, and access data and/or information associated with the collaboration system. For example, the data modeling service may receive the indication of the selection of that at least recommended collaborator and record it. In one case, the indication of the selection of that at least recommended collaborator may be recorded as being a preferred collaborator of the user who made the selection. In another example, the data modeling service may collect and store one or more files, collaboration data associated with a file, and/or one or more contacts associated with a user of the file. In another example, the data modeling service may receive data associated with a file created with an application.

When the indication of the selection of the at least one recommended collaborator is recorded at a data modeling service, flow proceeds to operation 506 where a priority of a plurality of weights assigned to collaboration data associated with the application is adjusted. For example, each piece of collaboration data may be assigned a weight. In one example, the higher the assigned weight, the more priority that piece of collaboration data will have when ranking recommended collaborators in a ranking order. For example, email collaboration data may be assigned a higher weight than instant messaging collaboration data. In this example, a recommended collaborator having 10 email interactions with a user requesting recommended collaborators may receive a higher ranking than a recommended collaborator having 10 instant messaging interactions with the user requesting recommended collaborators. In this regard, the priority of the weights assigned to the collaboration data (e.g., the email and/or instant messaging data) may be adjusted. For example, the weight assigned to the email collaboration data may be adjusted such that the priority of the weight assigned to the email collaboration data is adjusted to be lower than the priority of the weight assigned to the instant messaging collaboration data. In one case, the priority of the plurality of weights assigned to collaboration data may be adjusted using a settings control.

When a priority of a plurality of weights assigned to collaboration data associated with the application is adjusted, flow proceeds to operation 508 where a ranking order of the recommended collaborators is updated based at least in part on the adjusted priority of the plurality of weights assigned to the collaboration data associated with the application. For example, when email collaboration data is assigned a higher weight than instant messaging collaboration data, a recommended collaborator having 10 email interactions with a user requesting recommended collaborators may receive a higher ranking than a recommended collaborator having 10 instant messaging interactions with the user requesting recommended collaborators. When the priority of the weight assigned to the to the email collaboration data is adjusted to be lower than the priority of the weight assigned to the instant messaging collaboration data, a recommended collaborator having 10 instant messaging interactions with a user requesting recommended collaborators may receive a higher ranking than a recommended collaborator having 10 email interactions with the user requesting recommended collaborators. In this example, the ranking order of the recommended collaborators may be updated such that the collaborator having 10 instant messaging interactions with a user requesting recommended collaborators is now ranked higher than the collaborator having 10 email interactions with a user requesting recommended collaborators. In another example, the ranking order of the recommended collaborators may be updated to include a recommended collaborator selected in the list of recommended collaborators at the top of the ranking order.

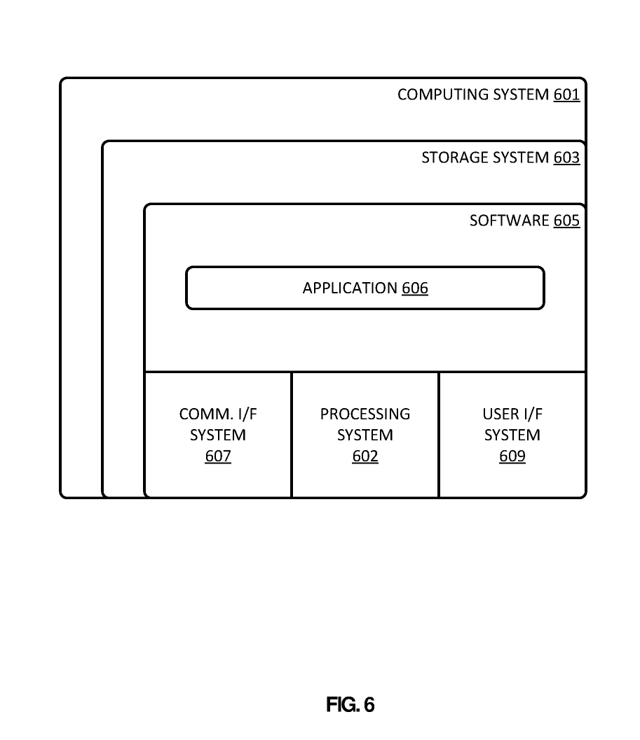

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes application 606, which is representative of the applications discussed with respect to the preceding FIGS. 1-5, including word processing applications described herein. When executed by processing system 602 to enhance collaboration, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced application collaboration.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced application collaboration. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising one or more computer readable storage media; and program instructions stored on the one or more computer readable storage media that, when executed by at least one processor, cause the at least one processor to at least: receive, at a data modeling service, collaboration data associated with at least one application; create a collaboration graph for representing the collaboration data associated with the at least one application; query the collaboration graph to identify a plurality of recommended collaborators for collaborating within the at least one application; and rank, in a ranking order, the plurality of recommended collaborators based on a set of criteria. In further examples, the application includes at least one of a word processing application, a spreadsheet application, and an electronic slide presentation application. In further examples, the application includes an email application. In further examples, the collaboration graph comprises a plurality of nodes and a plurality of edges where each edge of the plurality of edges connects two nodes. In further examples, each node of the plurality of nodes represents a user of the at least one application, and wherein each node of the plurality of nodes includes collaboration data associated with the user of the at least one application. In further examples, each edge of the plurality of edges includes an indication of a number of files that have been collaborated on between each user associated with each node connected by the edge. In further examples, the collaboration data comprises email data, instant messaging data, historical file data, organizational hierarchy data, meeting data, file contextual data, expertise data, and user influence data. In further examples, the set of criteria includes a collaboration frequency, a collaboration recency, a collaboration distance, file contextual data, expertise data, and a user influence score. In further examples, the program instructions, when executed by the at least one processor, further cause the at least one processor to assign a plurality of weights to the collaboration data. In further examples, the program instructions, when executed by the at least one processor, further cause the at least one processor to send a list of recommended collaborators to a client computing device based on the ranking order.

Further aspects disclosed herein provide an exemplary computer-implemented method for providing recommended collaborators, the method comprising: receiving a request for recommended collaborators for collaborating within at least one application; querying a collaboration graph to identify a plurality of recommended collaborators for collaborating within the at least one application; determining a ranking order of the plurality of recommended collaborators based on a set of criteria; and sending a list of recommended collaborators based on the ranking order to a client computing device for display in a user interface. In further examples, the request for recommended collaborators includes file contextual data. In further examples, the collaboration graph comprises a plurality of nodes and a plurality of edges where each edge of the plurality of edges connects two nodes. In further examples, querying a collaboration graph to identify a plurality of recommended collaborators for collaborating within the at least one application comprises: identifying a starting node from the plurality of nodes, the starting node associated with a user of the at least one application requesting recommended collaborators; and identifying a set of nodes from the plurality of nodes having a predetermined distance from the starting node. In further examples, the set of criteria includes a collaboration frequency, a collaboration recency, a collaboration distance, file contextual data, expertise data, and a user influence score. In further examples, determining the ranking order of the plurality of recommended collaborators based on the set of criteria comprises at least: measuring the collaboration frequency, the collaboration recency, and the collaboration distance; identifying similarities between the file contextual data of a user of the at least one application requesting recommended collaborators and the file contextual data of the plurality of recommended collaborators; identifying similarities between the file contextual data of the user of the at least one application requesting recommended collaborators and the expertise data of the plurality of recommended collaborators; and calculating the user influence score of the plurality of recommended collaborators. In further examples, determining the ranking order of the plurality of recommended collaborators based on the set of criteria further comprises at least assigning a plurality of weights to collaboration data associated with the plurality of recommended collaborators. In further examples, the computer-implemented method may further comprise receiving, at a data modeling service, collaboration data associated with the at least one application. In further examples, the computer-implemented method may further comprise updating the collaboration graph with the received collaboration data.

Additional aspects disclosed herein provide an exemplary system comprising at least one processor; and memory encoding computer executable instructions that, when executed by the at least one processor, perform a method for updating a ranking order of recommended collaborators, the method comprising: receiving an indication of a selection of at least one recommended collaborator displayed within an application in a user interface; recording the indication of the selection of the at least one recommended collaborator at a data modeling service; adjusting a priority of a plurality of weights assigned to collaboration data associated with the application; and updating a ranking order of the recommended collaborators based at least in part on the adjusted priority of the plurality of weights assigned to the collaboration data associated with the application.

Techniques for providing recommended collaborators are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of collaboration systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
receive, at a data modeling service, collaboration data associated with at least one application;
create a collaboration graph for representing the collaboration data associated with the at least one application;
query the collaboration graph to identify a plurality of recommended collaborators for collaborating within the at least one application; and
rank, in a ranking order, the plurality of recommended collaborators based on a set of criteria.

2. The system of claim 1, wherein the application includes at least one of a word processing application, a spreadsheet application, and an electronic slide presentation application.

3. The system of claim 1, wherein the application includes an email application.

4. The system of claim 1, wherein the collaboration graph comprises a plurality of nodes and a plurality of edges where each edge of the plurality of edges connects two nodes.

5. The system of claim 4, wherein each node of the plurality of nodes represents a user of the at least one application, and wherein each node of the plurality of nodes includes collaboration data associated with the user of the at least one application.

6. The system of claim 4, wherein each edge of the plurality of edges includes an indication of a number of files that have been collaborated on between each user associated with each node connected by the edge.

7. The system of claim 1, wherein the collaboration data comprises email data, instant messaging data, historical file data, organizational hierarchy data, meeting data, file contextual data, expertise data, and user influence data.

8. The system of claim 1, wherein the set of criteria includes a collaboration frequency, a collaboration recency, a collaboration distance, file contextual data, expertise data, and a user influence score.

9. The system of claim 1, wherein the program instructions, when executed by the at least one processor, further cause the at least one processor to assign a plurality of weights to the collaboration data.

10. The system of claim 1, wherein the program instructions, when executed by the at least one processor, further cause the at least one processor to send a list of recommended collaborators to a client computing device based on the ranking order.

11. A computer-implemented method for providing recommended collaborators, the method comprising:
receiving a request for recommended collaborators for collaborating within at least one application;
querying a collaboration graph to identify a plurality of recommended collaborators for collaborating within the at least one application;
determining a ranking order of the plurality of recommended collaborators based on a set of criteria; and
sending a list of recommended collaborators based on the ranking order to a client computing device for display in a user interface.

12. The computer-implemented method of claim 11, wherein the request for recommended collaborators includes file contextual data.

13. The computer-implemented method of claim 11, wherein the collaboration graph comprises a plurality of nodes and a plurality of edges where each edge of the plurality of edges connects two nodes.

14. The computer-implemented method of claim 13, wherein querying a collaboration graph to identify a plurality of recommended collaborators for collaborating within the at least one application comprises:
identifying a starting node from the plurality of nodes, the starting node associated with a user of the at least one application requesting recommended collaborators; and
identifying a set of nodes from the plurality of nodes having a predetermined distance from the starting node.

15. The computer-implemented method of claim 11, wherein the set of criteria includes a collaboration frequency, a collaboration recency, a collaboration distance, file contextual data, expertise data, and a user influence score.

16. The computer-implemented method of claim 15, wherein determining the ranking order of the plurality of recommended collaborators based on the set of criteria comprises at least:
measuring the collaboration frequency, the collaboration recency, and the collaboration distance;
identifying similarities between the file contextual data of a user of the at least one application requesting recommended collaborators and the file contextual data of the plurality of recommended collaborators;
identifying similarities between the file contextual data of the user of the at least one application requesting recommended collaborators and the expertise data of the plurality of recommended collaborators; and
calculating the user influence score of the plurality of recommended collaborators.

17. The computer-implemented method of claim 16, wherein determining the ranking order of the plurality of recommended collaborators based on the set of criteria further comprises at least assigning a plurality of weights to collaboration data associated with the plurality of recommended collaborators.

18. The computer-implemented method of claim 11, further comprising receiving, at a data modeling service, collaboration data associated with the at least one application.

19. The computer-implemented method of claim 18, further comprising updating the collaboration graph with the received collaboration data.

20. A system comprising:
at least one processor; and
memory encoding computer executable instructions that, when executed by the at least one processor, perform a method for updating a ranking order of recommended collaborators, the method comprising:
receiving an indication of a selection of at least one recommended collaborator displayed within an application in a user interface;
recording the indication of the selection of the at least one recommended collaborator at a data modeling service;
adjusting a priority of a plurality of weights assigned to collaboration data associated with the application; and
updating a ranking order of the recommended collaborators based at least in part on the adjusted priority of the plurality of weights assigned to the collaboration data associated with the application.
